(19) United States
(12) Patent Application Publication
(10) Pub. No.: US 2023/0251689 A1
(43) Pub. Date: Aug. 10, 2023

(54) CURVED DISPLAY APPARATUS AND CURVED DISPLAY APPARATUS ATTACHING METHOD THEREOF

(71) Applicant: QISDA CORPORATION, Taoyuan City (TW)

(72) Inventors: Jiann-Ming Lo, Taoyuan City (TW); NGOC LUONG NGUYEN, New Taipei City (TW)

(73) Assignee: QISDA CORPORATION, Taoyuan City (TW)

(21) Appl. No.: 17/711,055

(22) Filed: Apr. 1, 2022

(30) Foreign Application Priority Data
Feb. 7, 2022 (CN) 202210115764.X

(51) Int. Cl. H05K 5/00

(52) U.S. Cl. CPC H05K 5/0017

(57) ABSTRACT

A curved display apparatus includes an adhesive member, a back frame and a flexible display panel. The back frame includes a curved attaching portion for disposing the adhesive member thereon. The curved attaching portion has a first curvature radius. The flexible display panel is combined with the back frame via the adhesive member. The adhesive member is stretched by the flexible display panel to allow that the flexible display panel elastically returns to have a second curvature radius. The first curvature radius is less than the second curvature radius.

### BACKGROUND OF THE INVENTION

### 1. Field of the Invention

The present invention relates to a curved display apparatus and a curved display apparatus attaching method thereof, and more specifically, to a curved display apparatus ensuring that a flexible display panel can have a desired curvature radius after the flexible display panel is attached to a back frame via an adhesive member and a curved display apparatus attaching method thereof.

### 2. Description of the Prior Art

In general, a conventional panel attaching method for a curved display apparatus involves attaching an adhesive tape to a curved display panel and top and bottom sides of a curved back frame having a desired curvature radius, so as to achieve an expected curved display effect that the curved display panel and the curved frame could have a same curvature radius. However, since the adhesive tape is stretched by the flexible display panel due to elastic recovery of the curved display panel, the expected curved display effect cannot be achieved. Furthermore, it may cause the problem that a thickness of a middle section of the curved display apparatus is significantly greater than thicknesses of two side sections of the curved display apparatus, so that the curved display apparatus has an insufficient curvature and an inconsistent apparatus thickness. In this condition, the hot bending process is usually performed on the flexible display panel before the aforesaid attaching process, so as to ensure that the flexible display panel could have the desired curvature radius. However, the aforesaid hot bending process may still cause the problem that the hot bending equipment cost is high and the manufacturing quality, yield, and stability of the hot bending process is difficult to maintain.

### SUMMARY OF THE INVENTION

The present invention provides a curved display apparatus. The curved display apparatus includes an adhesive member, a back frame, and a flexible display panel. The back frame includes a curved attaching portion for disposing the adhesive member thereon. The curved attaching portion has a first curvature radius. The flexible display panel is combined with the back frame via the adhesive member. The adhesive member is stretched by the flexible display panel to allow that the flexible display panel elastically returns to have a second curvature radius. The first curvature radius is less than the second curvature radius.

The present invention further provides a curved display apparatus attaching method. The curved display apparatus attaching method includes providing an adhesive member and a back frame, wherein the back frame includes a curved attaching portion for disposing the adhesive member thereon, and the curved attaching portion has a first curvature radius. The curved display apparatus attaching method further includes combining a flexible display panel with the back frame via the adhesive member, wherein the adhesive member is stretched by the flexible display panel to allow that the flexible display panel elastically returns to have a second curvature radius, and the first curvature radius is less than the second curvature radius.

The present invention further provides a curved display apparatus. The curved display apparatus includes an adhesive member, a back frame, and a flexible display panel. The back frame includes a curved attaching portion for disposing the adhesive member thereon. The curved attaching portion has a first curvature radius. The flexible display panel originally has a third curvature radius greater than the first curvature radius. The flexible display panel is combined with the back frame via the adhesive member. The adhesive member is stretched by the flexible display panel to allow that the flexible display panel elastically returns to have a second curvature radius greater than the first curvature radius, wherein the first curvature radius includes a plurality of first segment curvature radiuses, and the second curvature radius is a single value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a curved display apparatus according to an embodiment of the present invention.

FIG. 2 is an exploded diagram of the curved display apparatus in FIG. 1.

FIG. 3 is a flowchart of a curved display apparatus attaching method according to an embodiment of the present invention.

FIG. 4 is a partial cross-sectional diagram of the curved display apparatus in FIG. 1 along a cross-sectional line A-A.

FIG. 5 is a cross-sectional diagram of the curved display apparatus in FIG. 1 along a cross-sectional line B-B.

### DETAILED DESCRIPTION

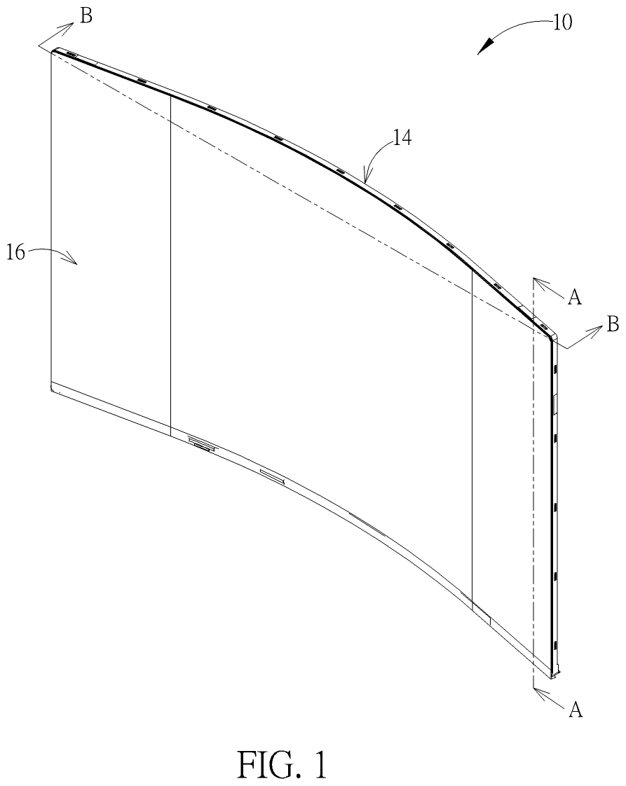

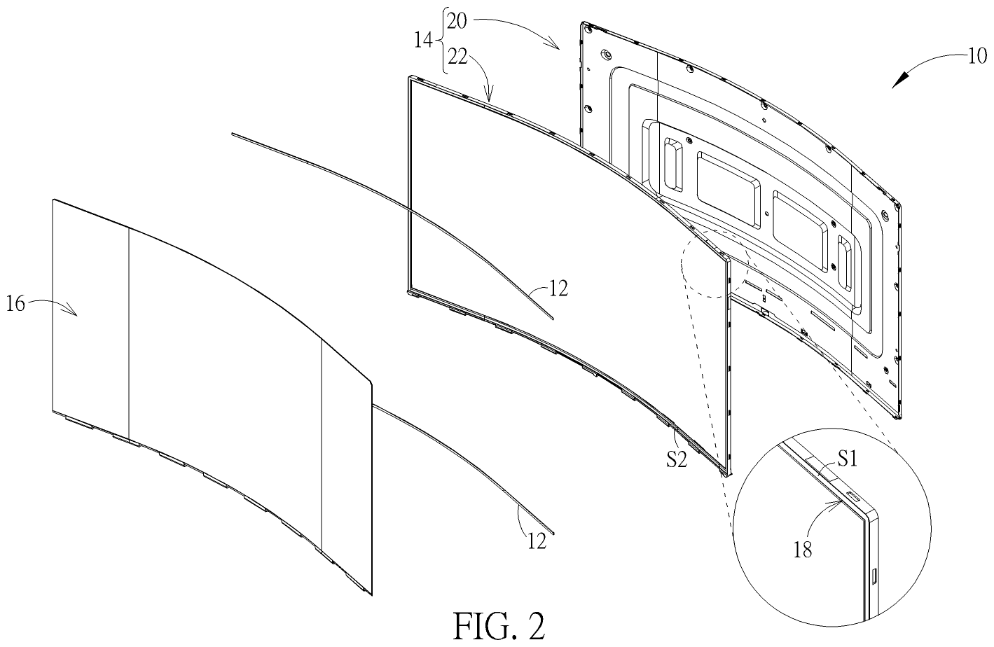

Please refer to FIG. 1 and FIG. 2. FIG. 1 is a diagram of a curved display apparatus 10 according to an embodiment of the present invention. FIG. 2 is an exploded diagram of the curved display apparatus 10 in FIG. 1. As shown in FIG. 1 and FIG. 2, the curved display apparatus 10 could be preferably applied to a curved display monitor (e.g., a curved LCD TV or a curved computer screen, but not limited thereto) and includes an adhesive member 12, a back frame 14, and a flexible display panel 16. The back frame 14 includes a curved attaching portion 18. The curved attaching portion 18 is configured to dispose the adhesive member 12 thereon for curving the flexible display panel 12 to be attached to the curved attaching portion 18 via the adhesive member 12, so as to complete the panel attaching process of the curved display apparatus 10.

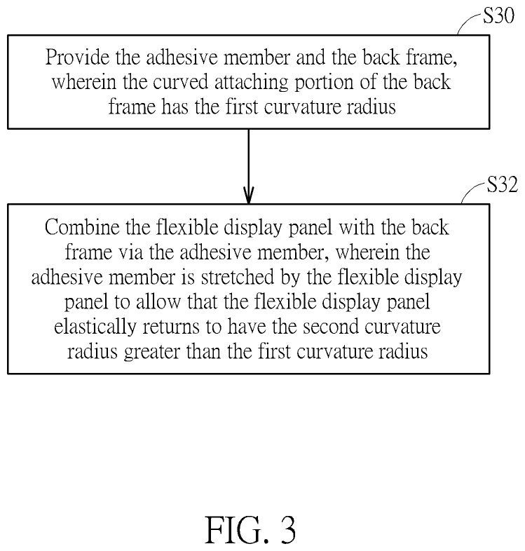

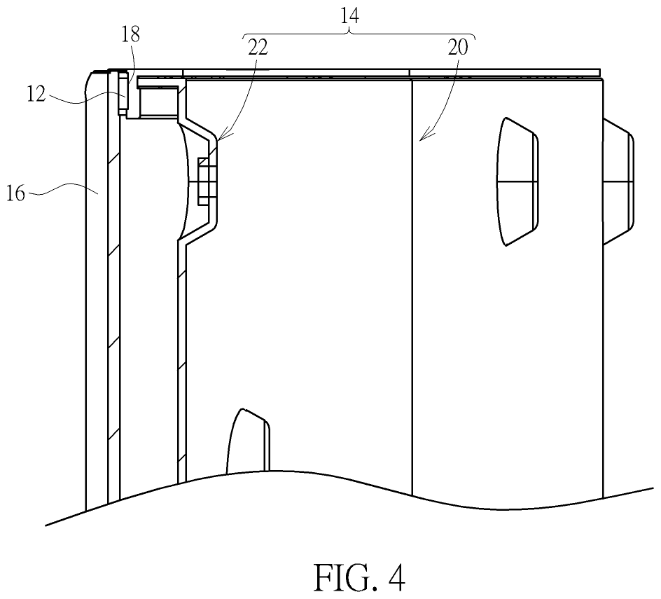

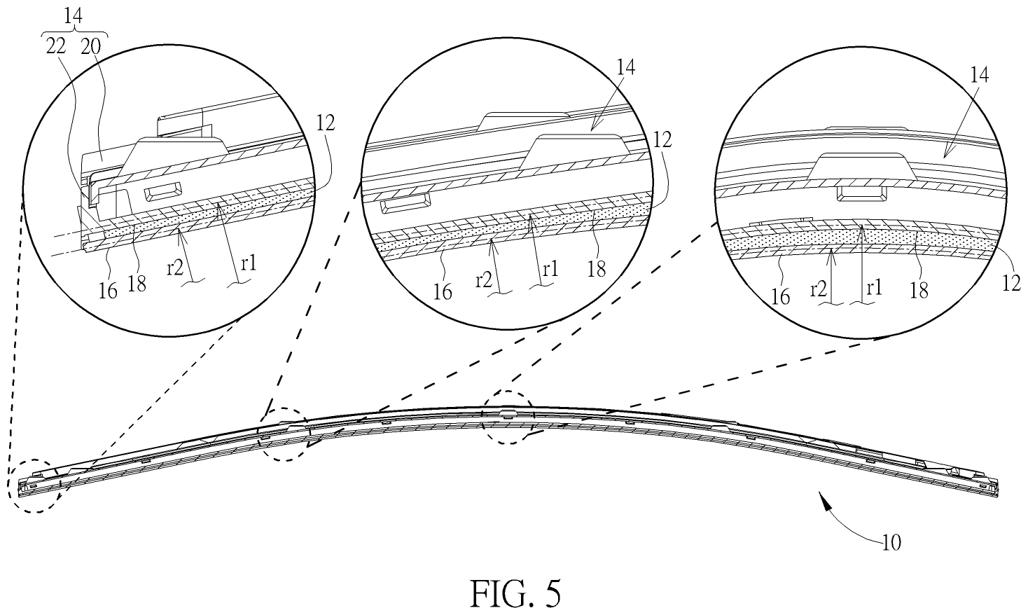

To be more specific, please refer to FIG. 2, FIG. 3, FIG. 4, and FIG. 5. FIG. 3 is a flowchart of a curved display apparatus attaching method according to an embodiment of the present invention. FIG. 4 is a partial cross-sectional diagram of the curved display apparatus 10 in FIG. 1 along a cross-sectional line A-A. FIG. 5 is a cross-sectional diagram of the curved display apparatus 10 in FIG. 1 along a cross-sectional line B-B.

More detailed description for steps of the curved display apparatus attaching method as shown in FIG. 3 is provided as follows. First, Step S30 is performed to provide the adhesive member 12 and the back frame 14. In this embodiment, the adhesive member 12 could be preferably made of PU foam material (but not limited thereto) and is attached to a top side S1 and a bottom side S2 of the curved attaching portion 18 (but not limited thereto, meaning that the present invention could adopt the one-sided attaching design in another embodiment). The back frame 14 could include a back board 20 and a panel frame 22. The curved attaching portion 18 is formed on the panel frame 22 (as shown in FIG. 2, but not limited thereto). The panel frame 22 is connected to the back board 20 in a concave-convex engagement manner as shown in FIG. 4 to form the back frame 14, but the present invention is not limited thereto, meaning that the present invention could adopt the design that the panel frame 22 could be integrally formed with the back board 20 in another embodiment.

After the adhesive member 12 is attached to the curved attaching portion 18, Step S32 is performed to combine the flexible display panel 16 with the back frame 14 via the adhesive member 12. In this embodiment, the present invention adopts the design that the curved attaching portion 18 has a plurality of segment curvature radiuses to make the flexible display panel 16 have one single curvature radius (i.e., a desired curvature radius of the flexible display panel 16 after being attached to the back frame 14 via the adhesive member 12) after the flexible display panel 16 is attached to the curved attaching portion 18, and the related radius setting depends on the practical application of the present invention.

For example, it is assumed that the desired curvature radius of the flexible display panel 16 after the flexible display panel 16 curves to be attached to the curved attaching portion 18 via the adhesive member 12 is a second curvature radius r2. As shown in Table 1, which is given by way of example (but not limited thereto), the first curvature radius of the curved attaching portion 18 could include a plurality of first segment curvature radiuses r1. The first segment curvature radius r1 corresponding to a middle section (located in a circular region corresponding to a middle section of the curved display apparatus 10 as shown in FIG. 5) of the curved attaching portion 18, which is equal to 988.6 mm, is less than the first segment curvature radius r1 corresponding to a side section (located in a circular region corresponding to a left side section of the curved display apparatus 10 as shown in FIG. 5) of the curved attaching portion 18, which is equal to 999 mm.

TABLE 1

| | First segment | Adhesive | Adhesive | Second segment |
|---|---|---|---|---|
| | curvature | thickness | deformation | curvature |
| | radius (mm) | (mm) | (mm) | radius (mm) |
| Middle | 998.6 | 1 | 0.4 | 1000 |
| section | | | | |
| Left | 998.8 | 1 | 0.2 | 1000 |
| middle | | | | |
| section | | | | |
| Side | 999 | 1 | 0 | 1000 |
| section | | | | |

In practical application, as shown in Table 1, the plurality of first segment curvature radiuses r1 could increase progressively from the middle section of the curved attaching portion 18 to the side section of the curved attaching portion 18, but the present invention is not limited thereto. Since a returning force of the flexible display panel 16 corresponding to the middle section of the curved attaching portion 18 is greater than a returning force of the flexible display panel 16 corresponding to the side section of the curved attaching portion 18, deformation of the adhesive member 12 stretched by the flexible display panel 16 can decrease progressively from the middle section of the curved attaching portion 18 to the side section of the curved attaching portion 18 (as shown in Table 1). Accordingly, after Step S32 is performed to combine the flexible display panel 16 with the back frame 16 via the adhesive member 12, deformation of the adhesive member 12 occurs due to the returning force provided by the flexible display panel 16, so as to allow that the flexible display panel 16 can elastically return to have the second curvature radius r2, wherein the second curvature radius r2 is a single value (i.e., 1000 mm as shown in Table 1), and the second curvature radius r2 is greater than the first segment curvature radius r1. Furthermore, if the flexible display panel 16 originally has a third curvature radius before the flexible display panel 16 is attached to the curved attaching portion 18, the third curvature radius could be preferably greater than the second curvature radius r2.

Via the design the curvature radius (i.e., the first curvature radius) of the curved attaching portion 18 is adjusted to be less than the desired curvature radius (i.e., the second curvature radius) of the flexible display panel 16 after being attached to the curved attaching portion 18 via the adhesive member 12, such as reducing the thickness of the curved attaching portion 18 to increase the concave curvature of the curved attaching portion 18 (as such, the curved attaching portion 18 has a smaller curvature radius) to reserve space for elastic returning of the flexible display panel 16, the curved display apparatus 10 ensures that the flexible display panel 16 can still have the desired curvature radius even when the flexible display panel 16 stretches the adhesive member 12 to cause elastic returning of the flexible display panel 16.

In such a manner, the present invention can surely prevent the situation that the expected curved display effect cannot be achieved and the thickness of the middle section of the curved display apparatus is significantly greater than the thicknesses of the two side sections of the curved display apparatus, so as to efficiently solve the prior art problem that the curved display apparatus has an insufficient curvature and an inconsistent apparatus thickness. Thus, the present invention not only improves the curved display effect of the curved display apparatus 10, but also makes the curved display apparatus 10 have a consistent apparatus thickness.

In addition, the flexible display panel 16 refers to a display panel with a variable curvature. In addition to the general flexible display panel, it also includes a display panel with a glass substrate and a plastic substrate. The degree of curvature of the display panel and the degree of difficulty of the curvature of the display panel are not limited to this present invention.

It should be mentioned that the curvature radius designs of the back frame and the flexible display panel are not limited to the aforesaid embodiment. That is, all designs in which the curvature radius of the curved attaching portion is adjusted to be less than the desired curvature radius of the flexible display panel after being attached to the curved attaching portion via the adhesive member may fall within the scope of the present invention. For example, in another embodiment, the curved display apparatus provided by the present invention could adopt the design in which the curved attaching portion of the back frame has only one smaller curvature radius, meaning that the first curvature radius of the curved attaching portion is a single value, to make the flexible display panel have a plurality of larger second segment curvature radiuses after the flexible display panel stretches the adhesive member to cause elastic returning of the flexible display panel. In another embodiment, the curved display apparatus provided by the present invention could adopt the design in which the curved attaching portion of the back frame has a plurality of smaller first segment curvature radiuses to make the flexible display panel have a plurality of larger second segment curvature radiuses after the flexible display panel stretches the adhesive member to cause elastic returning of the flexible display panel. In another embodiment, the curved display apparatus provided by the present invention could adopt the design in which the curved attaching portion of the back frame has only one smaller curvature radius to make the flexible display panel have only one larger curvature radius after the flexible display panel stretches the adhesive member to cause elastic returning of the flexible display panel. As for the related description for the second segment curvature radius, it could be reasoned by analogy according to the aforesaid embodiment and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A curved display apparatus comprising:
an adhesive member;
a back frame comprising a curved attaching portion for disposing the adhesive member thereon, the curved attaching portion having a first curvature radius; and
a flexible display panel combined with the back frame via the adhesive member, the adhesive member being stretched by the flexible display panel to allow that the flexible display panel elastically returns to have a second curvature radius, the first curvature radius being less than the second curvature radius.

2. The curved display apparatus of claim 1, wherein the first curvature radius comprises a plurality of first segment curvature radiuses, and the first segment curvature radius corresponding to a middle section of the curved attaching portion is equal to or less than the first segment curvature radius corresponding to a side section of the curved attaching portion.

3. The curved display apparatus of claim 2, wherein the plurality of first segment curvature radiuses increases progressively from the middle section of the curved attaching portion to the side section of the curved attaching portion.

4. The curved display apparatus of claim 1, wherein deformation of the adhesive member stretched by the flexible display panel decreases progressively from a middle section of the curved attaching portion to a side section of the curved attaching portion.

5. The curved display apparatus of claim 1, wherein the second curvature radius is a single value.

6. The curved display apparatus of claim 1, wherein the adhesive member is made of PU foam material.

7. The curved display apparatus of claim 1, wherein the adhesive member is attached to at least one of a top side and a bottom side of the curved attaching portion.

8. The curved display apparatus of claim 1, wherein the back frame comprises a back board and a panel frame, the curved attaching portion is formed on the panel frame, and the panel frame is connected to or integrally formed with the backboard to form the back frame.

9. The curved display apparatus of claim 1, wherein the flexible display panel originally has a third curvature radius, and the third curvature radius is greater than the first curvature radius and the second curvature radius.

10. A curved display apparatus attaching method comprising:
providing an adhesive member and a back frame, the back frame comprising a curved attaching portion for disposing the adhesive member thereon, the curved attaching portion having a first curvature radius; and
combining a flexible display panel with the back frame via the adhesive member, the adhesive member being stretched by the flexible display panel to allow that the flexible display panel elastically returns to have a second curvature radius, the first curvature radius being less than the second curvature radius.

11. The curved display apparatus attaching method of claim 10, wherein the first curvature radius comprises a plurality of first segment curvature radiuses, and the first segment curvature radius corresponding to a middle section of the curved attaching portion is equal to or less than the first segment curvature radius corresponding to a side section of the curved attaching portion.

12. The curved display apparatus attaching method of claim 11, wherein the plurality of first segment curvature radiuses increases progressively from the middle section of the curved attaching portion to the side section of the curved attaching portion.

13. The curved display apparatus attaching method of claim 10, wherein deformation of the adhesive member stretched by the flexible display panel decreases progressively from a middle section of the curved attaching portion to a side section of the curved attaching portion.

14. The curved display apparatus attaching method of claim 10, wherein the second curvature radius is a single value.

15. The curved display apparatus attaching method of claim 10, wherein the adhesive member is made of PU foam material.

16. The curved display apparatus attaching method of claim 10, wherein the adhesive member is attached to at least one of a top side and a bottom side of the curved attaching portion.

17. The curved display apparatus attaching method of claim 10, wherein the back frame comprises a back board and a panel frame, the curved attaching portion is formed on the panel frame, and the panel frame is connected to or integrally formed with the back board to form the back frame.

18. The curved display apparatus attaching method of claim 10, wherein the flexible display panel originally has a third curvature radius, and the third curvature radius is greater than the first curvature radius and the second curvature radius.

19. A curved display apparatus comprising:
an adhesive member;
a back frame comprising a curved attaching portion for disposing the adhesive member thereon, the curved attaching portion having a first curvature radius; and
a flexible display panel originally having a third curvature radius greater than the first curvature radius, the flexible display panel being combined with the back frame via the adhesive member, the adhesive member being stretched by the flexible display panel to allow that the flexible display panel elastically returns to have a second curvature radius greater than the first curvature radius, wherein the first curvature radius comprises a plurality of first segment curvature radiuses, and the second curvature radius is a single value.

20. The curved display apparatus of claim 19, wherein deformation of the adhesive member stretched by the flexible display panel decreases progressively from a middle section of the curved attaching portion to a side section of the curved attaching portion.
